(19) United States
(12) Patent Application Publication
(10) Pub. No.: US 2010/0262632 A1
(43) Pub. Date: Oct. 14, 2010

(54) DATA TRANSFER FROM ON-LINE TO ON-PREMISE DEPLOYMENT

(75) Inventors: Shikha Jain, Redmond, WA (US); Michael J. Ott, Redmond, WA (US); Douglas W. Wood, Issaquah, WA (US); David R. Shutt, Seattle, WA (US); Howard A. Hurst, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/423,461

(22) Filed: Apr. 14, 2009

(51) Int. Cl. G06F 17/30; G06Q 99/00; G06Q 50/00

(52) U.S. Cl. 707/809; 707/E17.006; 707/E17.032; 705/1.1

(57) ABSTRACT

A customer can request migration of its data from a multi-tenant hosting environment to a local environment. The customer's data is pulled from the multi-tenant hosting environment and scrubbed so that it is compatible with a local version of the application previously hosted in the multi-tenant hosting environment. The data is made available to the customer at a secure location in the hosting environment. The customer retrieves the data, after proper authentication, to its local data store, and then imports the data into the local version of the application. Users of the local version of the application are then mapped from previous multi-jurisdictional identifications to local user identifications in the application.

### BACKGROUND

A hosted application is a software application where the software resides on servers that are accessed through a wide-area network, such as the Internet, rather than more traditional software that is installed on a local server or on individual client computers. Hosted applications may also be known as Internet-applications, application service providers (“ASPs”), web-based applications, or on-line applications. Hosted applications are commonly utilized concurrently by multiple subscriber organizations, called “tenants.”

Some hosted applications utilize a multi-tier architecture in which the middle tier that performs the application logic is separated from the database tier where application and tenant data is stored. In many cases, the database tier is shared among all of the tenants. Use of a shared database tier in this manner is problematic, however, because a scheduled or unscheduled database outage in such a system will affect all of the tenants simultaneously. Moreover, because all tenants share the same database tier, application performance for all of the tenants may be significantly reduced if just one tenant places an excessive load on the database, such as when the tenant desires to migrate its data to a different deployment. Reduced performance may be unacceptable to the tenants of such a system. Additionally, when a single database is utilized for all of the tenants of a hosted application, it may be difficult for a tenant to customize the schema that is utilized to store the database.

Other hosted applications utilize a multi-tier architecture in which each tenant utilizes a middle tier and a database tier that are maintained separately from all other tenants. This type of architecture may be implemented, for instance, by providing each tenant with a virtual server computer for hosting the middle tier and the database tier. This type of architecture allows outages to be confined to a single tenant or a small group of tenants, and reduces the possibility that an excessive load by one tenant will impact application performance for other tenants. This type of architecture, however, suffers from several other significant drawbacks. In particular, it can be complex and expensive to operationally maintain the separate operating system and application installation on the virtual server computer provided for each hosted tenant. Moreover, allocated hardware resources may remain unused by tenants that cannot utilize all of the processing and storage capabilities of a dedicated virtual server computer.

Customer relationship management data is used by many companies and other organizations in order to assist them in managing the relationships they have with their customers, and to consistently evaluate and improve customer service. Many times, especially when a company or other organization is relatively small, it makes sense to deploy customer relationship management (CRM) software according to a service model in which the company or organization uses the software that is hosted on-line by a remote host, as described above. In this way, the company or organization (the tenant) is able to share the cost associated with hosting the software with other businesses or organizations (other tenants), thereby reducing their costs.

However, as the company or organization grows, so does its CRM application needs. Under this type of expansion scenario, customers may prefer to transition from the service model to an on-premise model in which the CRM software (and corresponding data) is managed by the customer, itself, on the customer's local site.

It is currently difficult to transition from a CRM application in the hosted, service model to one in the on-premise model because this often involves the migration of large amounts of customer relations data from the hosting environment to the customer's local computing environment. Such a transition can affect the day-to-day use of the CRM system and result in business disruption, possible data loss, and the requirement for user training and experience with the local version of the application.

The discussion above is merely provided for general background information and is not intended to be used as an aid in determining the scope of the claimed subject matter.

### SUMMARY

A customer can request migration of its data from a multi-tenant hosting environment to a local environment. The customer's data is pulled from the multi-tenant hosting environment and scrubbed so that it is compatible with a local version of the application previously hosted in the multi-tenant hosting environment. The data is made available to the customer at a secure location in the hosting environment. The customer retrieves the data, after proper authentication, to its local data store, and then imports the data into the local version of the application. Users of the local version of the application are then mapped from previous multi-jurisdictional identifiers to local user identifiers in the application.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1-2C are software architecture diagrams illustrating aspects of a software architecture utilized in several illustrative embodiments.

FIGS. 3-3A is an architectural diagram illustrating migration of a customer's data from a hosting deployment to a local client deployment.

FIG. 4 illustrates components used in performing the migration shown in FIG. 3 in more detail.

FIG. 5 is a flow diagram illustrating the actions taken in the hosting environment to perform the data migration.

FIG. 6 is a flow diagram illustrating actions taken in the local client environment in performing the data migration.

FIG. 7 is a block diagram illustrating one embodiment of a general computing device.

### DETAILED DESCRIPTION

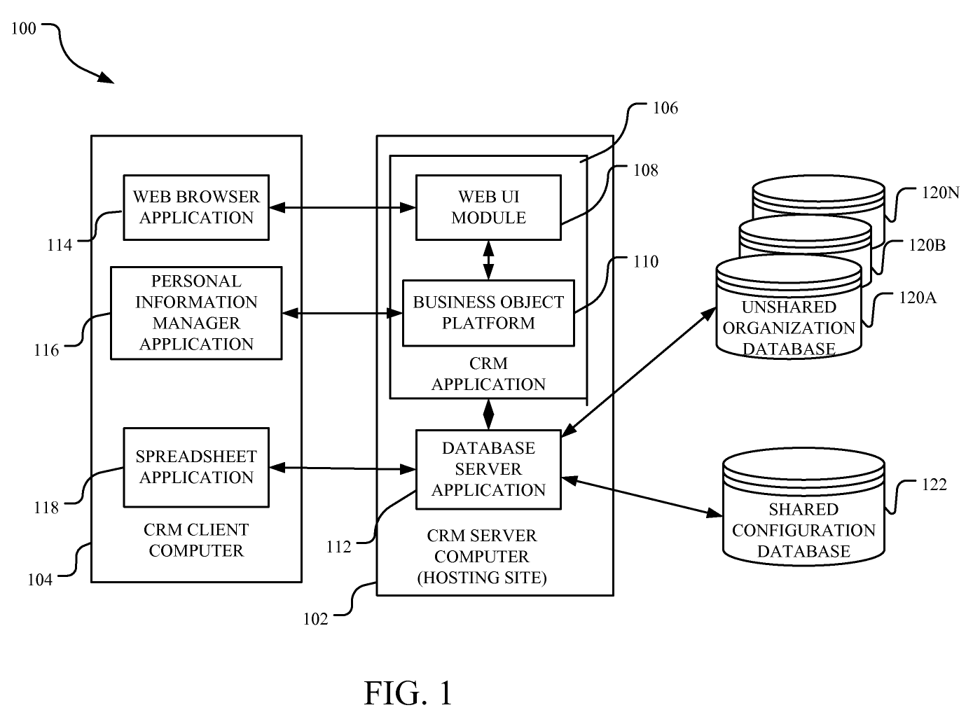

Prior to discussing the migration of data from a hosted deployment of an application to an on-premise deployment of the application, in detail, one embodiment of a hosted, multi-tenant architecture will first be described. FIG. 1 is a network and software architecture diagram that provides details regarding an illustrative operating environment for the embodiments presented herein. As discussed briefly above, the illustrative computing system 100 shown in FIG. 1 provides a hosted, multi-tenant application program. In the embodiments presented herein, the application program is a program for providing CRM functionality. CRM applications allow businesses to manage the relationships with their customers, including the capture, storage, and analysis of customer information. It should be appreciated, however, that any type of hosted application may be implemented utilizing the technologies presented herein, including other types of hosted business applications.

Through the use of the system 100 shown in FIG. 1, multiple organizations, referred to herein as “tenants,” may concurrently utilize the computing resources provided by the system 100. The illustrative computing system 100 shown in FIG. 1 includes a CRM server computer (or hosting site) 102. The CRM server computer 102 executes a CRM application 106 and maintains one or more associated databases, described more fully herein. The CRM application 106 provides functionality for managing relationships with business customers, including the capture, storage, and analysis of customer information.

The CRM functionality provided by the CRM application 106 may be accessed through the use of a web browser application 114 executing on a client computer, such as the CRM client computer 104. The CRM application 106 includes a web user interface (“UI”) module 108 for exposing a web-compatible network interface. In this manner, the CRM client computer 104 can be utilized to access functionality provided by the on-line version (or hosted version) of the CRM application 106 for creating and viewing customer information, for communicating with customers via the CRM application 106, and for performing other CRM-related functions.

According to embodiments presented herein, the CRM application 106 also includes a business object platform 110. The business object platform 110 is a software platform for executing software components that perform the actual business processing for the CRM application 106. The business object platform 110 operates in conjunction with the web UT module 108 to make this functionality accessible through a web interface. Aspects of the functionality provided by the CRM application 106 may also be accessed through a plug-in to a personal information manager (“PIM”) application 116. In one embodiment, a plug-in executing within the PIM application 116 communicates directly with the business object platform 110 to enable this functionality. Of course, other functionality can be made available in other ways as well.

As shown in FIG. 1, the on-line version of the CRM application 106 operates in conjunction with a database server application 112, which also executes on the CRM server computer 102. The database server application 112 provides functionality for creating, maintaining, accessing, and updating one or more databases. It should be appreciated that any suitable database server application may be utilized in the manner described herein.

Through the use of the database server application 112, the CRM application 106 is operative to maintain several databases. In particular, the CRM application 106 maintains a shared configuration database 122. As will be described in greater detail herein, the CRM application 106 utilizes the shared configuration database 122 to store global system-level information and data that is shared by the tenants. For instance, according to embodiments, the shared configuration database 122 may be utilized to store information about tenants, such as their name and contact information, information about which tenant particular users are members of, and information mapping authentication data to a specific user. In one implementation presented herein, the shared configuration database 122 is also utilized to store data defining a scale group to which each tenant hosted by the CRM application 106 has been assigned.

The CRM application 106 also maintains the unshared organization databases 120A-120N. The unshared organization databases 120A-120N are utilized by the on-line CRM application 106 to store private, unshared data for the tenants. Each unshared organization database 120A-120N is associated with a particular tenant and its contents are inaccessible to the other tenants. Accordingly, each unshared organization database 120A-120N is utilized to store private tenant data for the associated tenant. Each unshared organization database 120A-120N may also be utilized to store customizations to the on-line CRM application 106 made by the associated tenant including, but not limited to, customized entities, attributes, relationships, forms, views, code-level extensibility plug-ins, and any other type of customization to the CRM application 106. It should be appreciated that other types of databases and database schema may be utilized to store the global system-level information and the tenant data according to other embodiments.

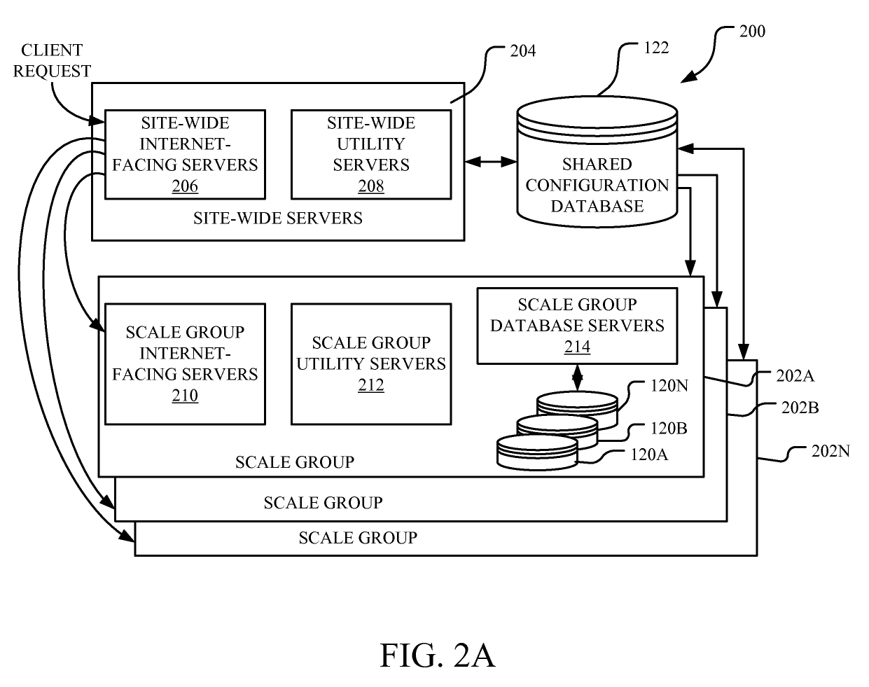

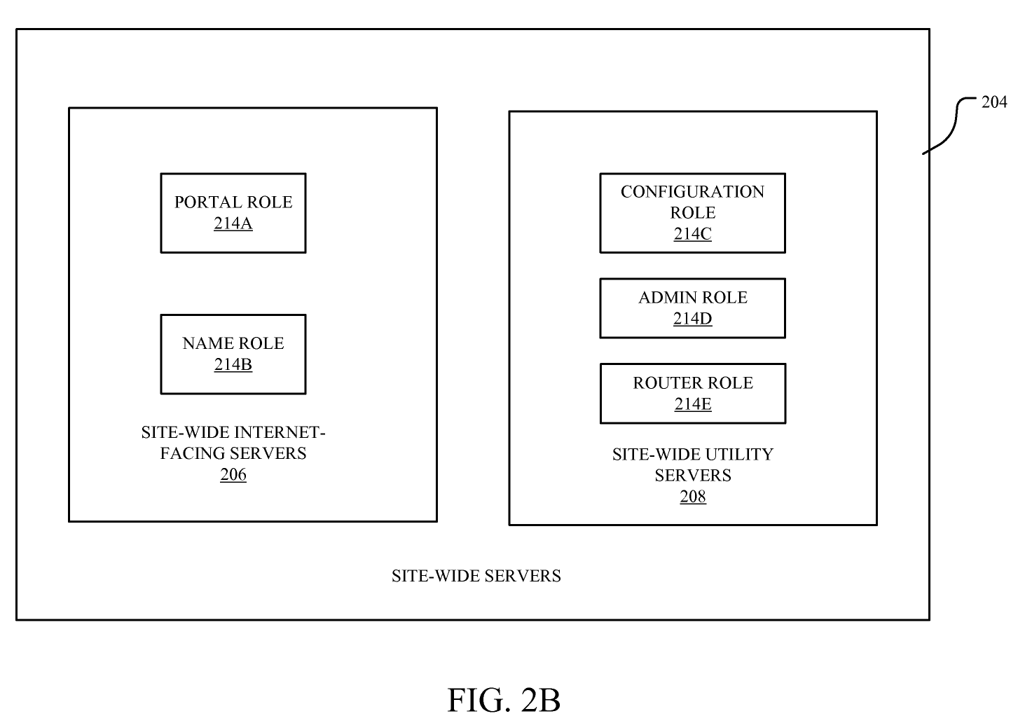

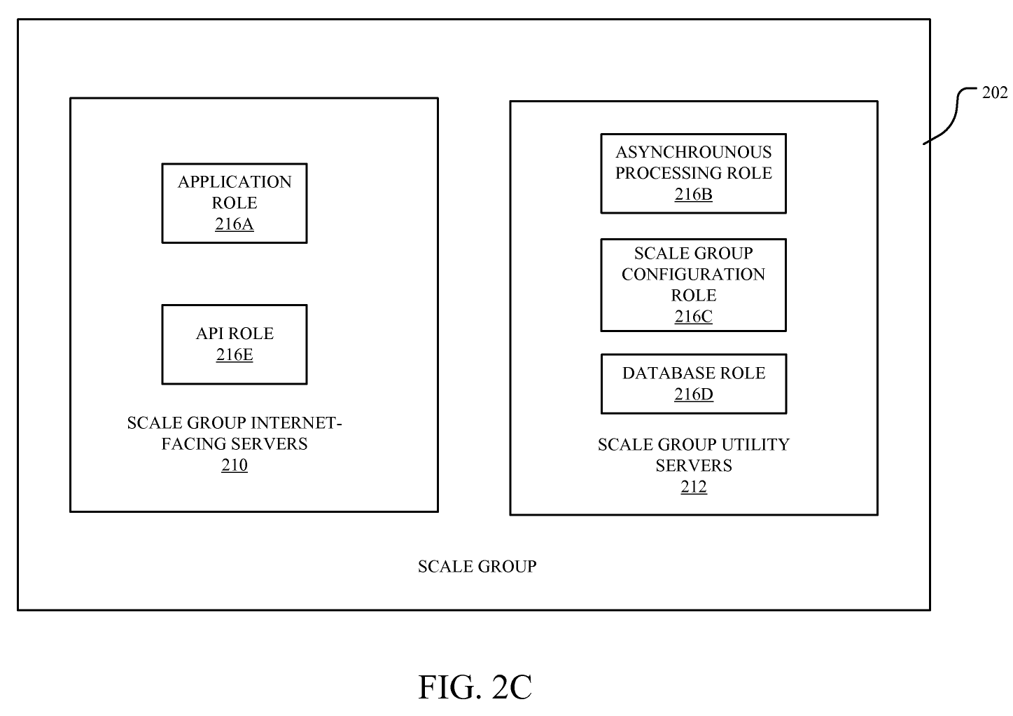

FIG. 2A shows another embodiment of the invention for providing a hosted, multi-tenant application that utilizes per-tenant unshared private databases. In this embodiment, a system 200 is provided wherein the servers that provide the CRM functionality described herein are organized into the scale groups 202A-202N. The scale groups 202A-202N are logical groupings of servers, each of which has one or more tenants assigned thereto.

In one implementation, each scale group 202A-202N includes a shared middle tier and a database tier for supporting the tenants assigned to the scale group. Scale group Internet-facing servers 210 implement the middle tier by executing the on-line CRM application 106, while scale group database servers 214 implement the database tier by executing the database server application 112. One or more scale group utility servers 212 are also provided within each scale group 202A-202N for performing utility functions, such as reporting services, load balancing, provisioning, configuration, statistics, and others. Each scale group may also include its own configuration database that is private to the scale group but shared among all of the tenants of the scale group. As will be described in greater detail below, the servers in each of the scale groups 202A-202N may be assigned to one or more roles for performing these functions.

When a new tenant is provisioned within the system 200, the tenant is assigned to one of the scale groups 202A-202N. At this time, one of the scale group database servers 214 in the assigned scale group creates a private, unshared database 120 for the tenant. In this manner, the private, unshared database 120 for the new tenant is created and stored in the assigned scale group 202. An association, or mapping, between the tenant and the assigned scale group 202 is also created in the shared configuration database 122.

As shown in FIG. 2A, the system 200 also includes one or more site-wide servers 204. In particular, one or more site-wide Internet-facing servers 206 are provided along with one or more site-wide utility servers 208. The site-wide Internet-facing servers 206 perform site-wide functions for the system 200, including processing sign-in and sign-up requests, site-wide messaging, help functions, and functions for mapping each tenant to the appropriate scale group 202A-202N. The site-wide utility servers 208 provide facilities for site configuration, billing, customer support, and others. The site-wide servers 204 may also be assigned to one or more roles for performing these functions.

Network client requests to access the on-line (or hosted) application 106 are received at the site-wide Internet-facing servers 206. In response to receiving such requests, the shared configuration database 122 is consulted to locate the scale group 202A-202N hosting the private, unshared database 120 for the tenant making the request. Once the appropriate scale group 202A-202N has been located, the incoming request is redirected to the scale group Internet-facing servers 210 in the identified scale group 202A-202N for processing.

FIG. 2B shows additional details regarding the roles to which the site-wide server computers may be assigned. As shown in FIG. 2B, the site-wide Internet-facing servers 206 may be assigned to a portal role 214A and/or to a name role 214B. Server computers assigned to the portal role 214A are configured to provide the user interfaces (the “portal”) for the system 100 that are not tenant specific. For example, server computers assigned to the portal role 214A may be configured to provide sign-up and sign-in Web pages. Server computers assigned to the name role 214B are configured to provide domain name system (DNS) services. For instance, server computers assigned to the name role 214B may be configured to provide network addresses corresponding to sub-domains unique to each tenant. The definition of where tenant address records should point to comes from the configuration role 214C. It should be appreciated that the site-wide Internet-facing servers 206 may be assigned to one or more of the roles shown in FIG. 2B or to other roles not illustrated or described herein.

FIG. 2B shows that the site-wide utility servers may be assigned to a configuration role 214C, an administration role 214D, and/or a router role 214E. Servers assigned to the configuration role 214C are responsible for exposing configuration information from the shared configuration database 122 to other roles. For instance, servers assigned to the configuration role 214C may expose data regarding the available scale groups 202, data regarding the mapping of tenants to scale groups 202, and the resource limits for the scale groups 202. Other information may also be exposed.

Servers assigned to the administration role 214D are configured for performing administrative tasks for manipulating the system 200. For example, a server assigned to the administration role 214D may be configured to execute commands to create scale groups, move tenants between scale groups, and to provision tenants for testing, support, or monitoring purposes. Servers assigned to the router role 214E are configured to redirect certain actions to an appropriate scale group 202. For instance, a server assigned to the router role 214E may be configured to route a job to provision a new tenant, upgrade the data for a tenant, retrieve data for a tenant for migration to a different deployment or to delete a tenant from the appropriate scale group 202. Other types of actions may be routed in a similar manner. It should be appreciated that the site-wide utility servers 208 may be assigned to one or more of the roles shown in FIG. 2B or to other roles not illustrated or described herein.

FIG. 2C shows additional details regarding the roles to which the server computers in each of the scale groups 202 may be assigned. As shown in FIG. 2C, the scale group Internet-facing servers 210 are assigned to the application role 216A. Servers assigned to this role are responsible for providing the actual application 106 that is used by the tenants. Servers assigned to the application role 216A may also be configured to assign long-running tasks to a server computer assigned to an asynchronous processing role 216B. Server computers may also be assigned to an application programming interface (“API”) role 216E. The API role 216E allows its consumers to execute remote procedures through web service APIs, thereby enabling rich clients and other integration applications to access features provided by the system 200.

As also shown in FIG. 2C, the scale group utility servers 212 may be assigned to an asynchronous processing role 216B, the scale group configuration role 216C, and/or the database role 216D. Servers assigned to the asynchronous processing role 216B are configured to off-load long running operations from the application role 216A. Some examples include provisioning a new tenant, upgrading tenant data, deleting a tenant, bulk data import to a tenant, and bulk data extraction for a tenant. Servers assigned to the scale group configuration role 216C are responsible for maintaining configuration settings for the scale group. Examples include data identifying the servers that have been assigned to a scale group and data identifying the physical server that a tenant's data resides on. Server computers assigned to the database role 216D are configured to maintain the unshared organization databases 120. It should be appreciated that the scale group Internet-facing servers 210 and the scale group utility servers 212 may be assigned to one or more of the roles shown in FIG. 2C or to other roles not illustrated or described herein.

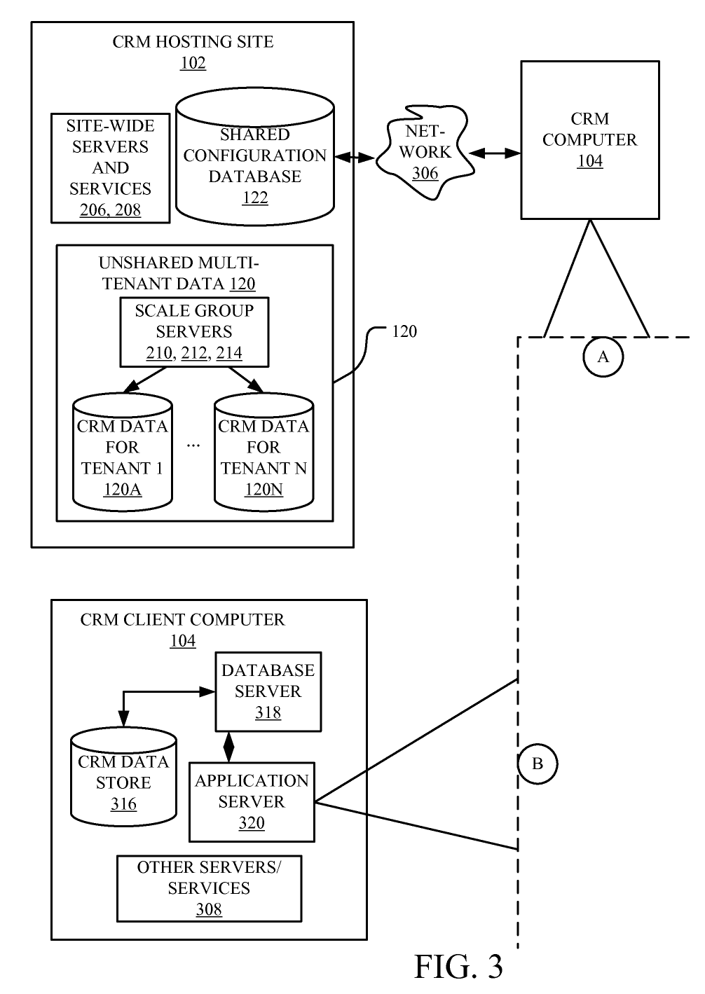

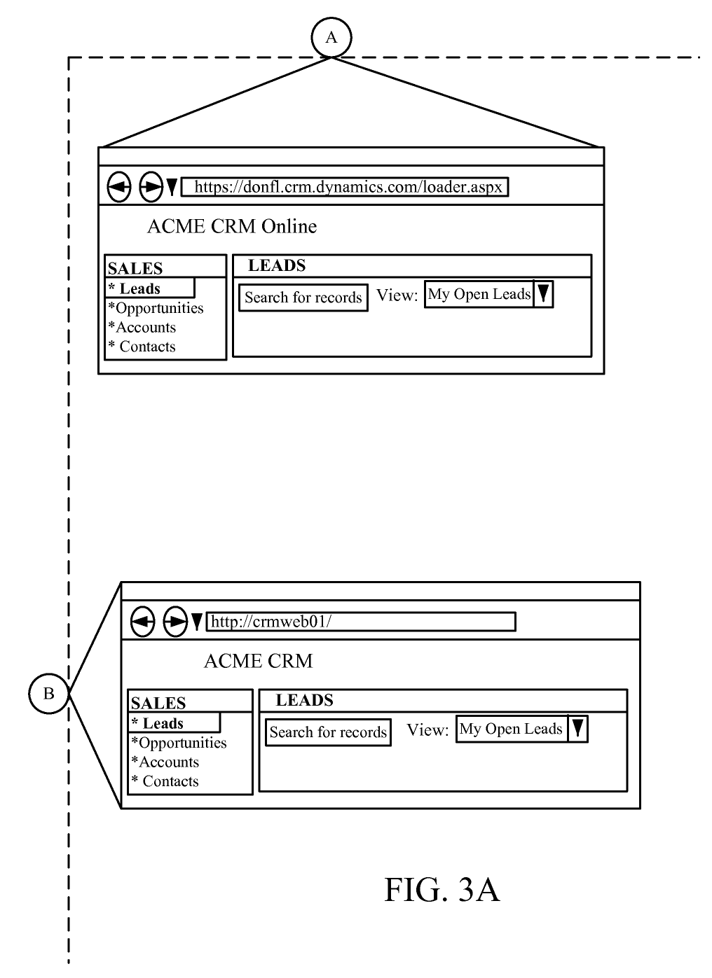

Despite the advantages of a hosted multi-tenant deployment, it may be desirable for organization or company to migrate its data from the hosted environment of system 100 to a local site such as CRM client computer 104, so that the CRM application is locally run and all the data is locally stored and maintained. This is illustrated in FIG. 3. The top half of FIG. 3 is used to run an on-line version of a CRM application according to a hosted service model as described above with respect to system 100 shown in FIGS. 1-2C, and similar items are similarly numbered. CRM client computer 104 accesses the on-line version of CRM application 106 to generate and update its data 120 over network 306. FIG. 3 also shows one embodiment of a user interface 300 that might be generated from the application server on CRM client computer 104 in the hosted environment.

As discussed above, it may be desirable for an organization to migrate its data from unshared multi-tenant data 120 on CRM hosting site 102 to an on-premise deployment of the CRM application on CRM client computer 104. This is shown at the bottom half of FIG. 3. In the on-premise deployment the client organization locally runs it own version of the CRM application on application server 320 and stores and maintains its own data on CRM data store 316 using database server 318. Migration of the data is indicated by arrow 302. FIG. 3 shows that the user interface generated by the application server 320, that is running the on-premise version of the CRM application, and designated as 304, is substantially the same as user interface 300. The difference reflects that the version of the CRM application being run on CRM client computer 104 is one suited for an on-premise deployment, in which the client runs the application and maintains the data itself, instead of an on-line deployment in which the client controls running of the hosted application over network 306.

FIG. 3 shows that CRM client computer 104 illustratively includes application server 320 that runs the on-premise version of the CRM application that was previously run as an on-line version illustrated in the top half of FIG. 3. It may be advantageous to have the code base for the on-premise version of the CRM application be substantially the same as the code base for the on-line version of the CRM application. Of course, there may be some features which are slightly different, causing the code base to be slightly different. For instance, web search features may be available in the on-line version and unavailable in the on-premise version, or vise versa. In any case, it can be seen from FIG. 3 that application server 320 on CRM client computer 104 runs an on-premise version of the same CRM application that is run (in an on-line version) in the hosted multi-tenant environment.

FIG. 3 also shows that, in the illustrated embodiment, CRM client computer 104 may have other servers and services 308, as well as, or instead of, those shown in the previous FIGS. For instance, other servers/services 308 may include an asynchronous service server, a site replication service (SRS) server, and application internet information services (IITS) server, and other servers or services which are used to run CRM client computer 104.

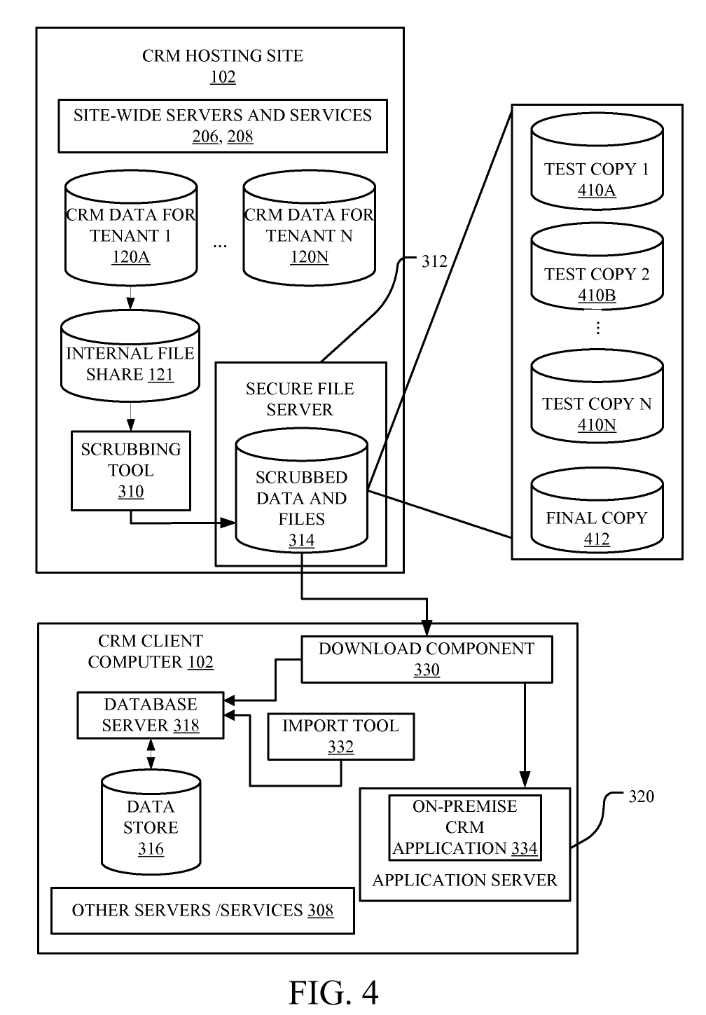

FIG. 4 shows certain features of hosting site 102 and client computer 104 that are used to migrate data, in more detail. In order to migrate data from the deployment on the hosting site 102 to the on-premise deployment, and in order to reduce the problems associated with data migration discussed in the background portion, FIG. 4 shows that CRM hosting site 102 is illustratively provided with scrubbing tool 310 and secure file server 312 which includes its own secure data store 314. Scrubbing tool 310 may be run on any of the computing components described above on CRM hosting site 102, or on its own dedicated component, such as its own server, or such as a remote server. Similarly, secure file server 312 and its corresponding data store 314 may be implemented in any of the components described above on CRM hosting site 102, or on additional components, such as an additional server and data store.

FIG. 4 also shows that CRM client computer 102 illustratively, includes download component 330 and import tool 332. Download component 330 allows CRM client computer 102 to download information from CRM hosting site 102. Any suitable downloading component can be used, such as a web browser, or other navigation tool that allows downloading of information either directly from CRM hosting site 102, or over a network, such as a wide area network. Import tool 332 is illustratively associated with the CRM application 334 run on the application server 320, and enables data to be populated to the application after it has been downloaded from CRM hosting site 102.

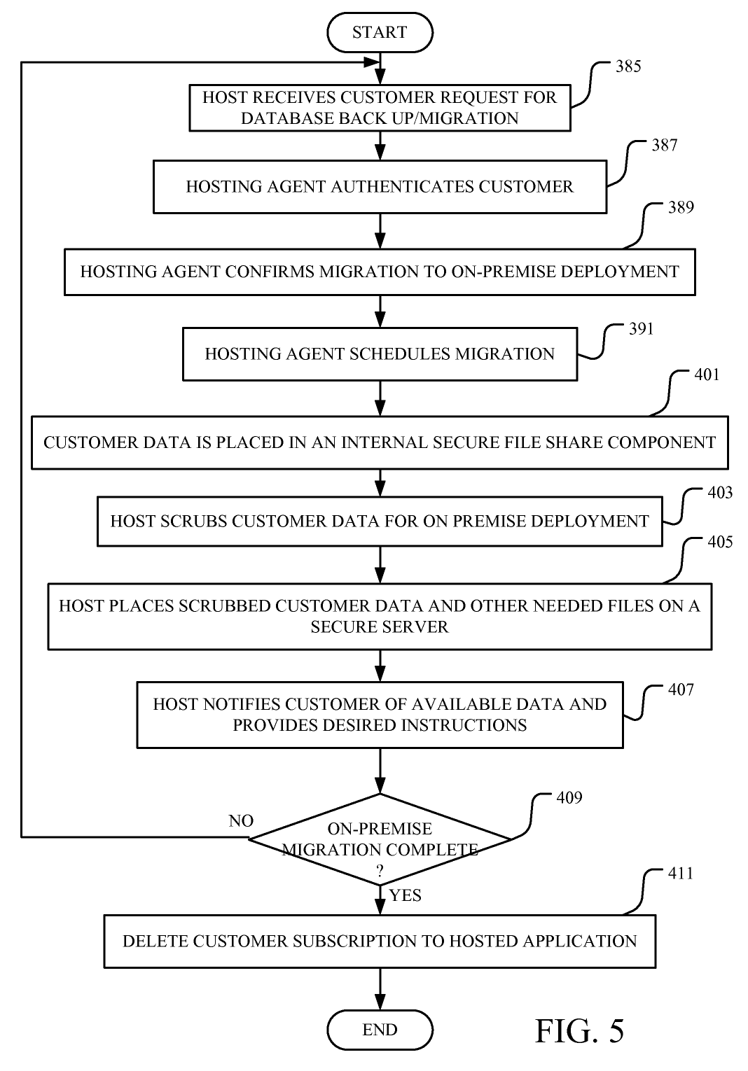

FIG. 5 is a flow diagram illustrating one embodiment of the operation of the components in FIG. 5 in which CRM hosting site 102 prepares the customer's data for migration from the on-line deployment at CRM hosting site 102 to an on-premise deployment at CRM client computer 102. It is first worth noting that, in order to migrate data, the data must be present. Therefore, it is assumed that the customer running CRM client computer 102 has already aggregated CRM data through an on-line version of a CRM application that is being hosted at CRM hosting site 102. In order to migrate the data, the CRM hosting computer 102 first receives a customer request for a database backup or migration. This is indicated by block 380 in FIG. 5. In one embodiment, the customer may make an electronic request for the data migration, or may simply contact a person at the hosting site and request the data migration by telephone. Of course, other ways of receiving the request at the CRM hosting site 102 can be used as well.

The hosting agent then authenticates the customer. This can also be done in a variety of different ways. For instance, the hosting agent may request certain information from the customer, such as a user identification and password. The hosting agent may also request information indicative of the fact that the customer has purchased an on-premise license for the on-premise version of the CRM application to which the customer data is being migrated. Similarly, the hosting agent may ensure that the customer that is requesting the data migration is also verified within the on-line system as being the entity that is in charge of the billing or that is otherwise in charge of (or the contact person for) the on-line account maintenance for the on-line version of the CRM application. Of course, a wide variety of other ways can be used to authenticate the customer. Having the hosting agent authenticate the customer making the request is indicated by block 387 in FIG. 5.

The hosting agent then confirms that the migration to the on-premise deployment has been requested and authenticated. This can also be done using electronic messaging, such as electronic mail, or other type of automated messaging, or it can be done by providing a confirmation code over the telephone from the hosting agent to a customer. This is indicated by block 389 in FIG. 5.

Once the hosting agent has received, authenticated, and confirmed the customer's request to migrate data to the on-premise deployment, the hosting agent schedules the data migration. In doing so, the hosting agent accesses the current data migration requests that are currently scheduled for the present week. These may be kept in a scheduling system on the site-wide servers or elsewhere. If a threshold number of migrations have already been scheduled, then the hosting agent pushes the data migration to a subsequent week in which the threshold number of data migrations have not yet been scheduled. Scheduling the data migration to occur during a week that has sufficient availability is done in order to ensure that the data will be available to the customer, when promised. Once the data migration has been scheduled, notice to that effect is again sent to the customer, either in an automated way, electronically, or by personal contact, or in any other desired way. Scheduling the data migration to the on-premise deployment is indicated by block 391 in FIG. 5.

The customer data is then retrieved from the unshared multi-tenant data component 120 and placed in an internal, secure, file share component, such as component 121 shown in FIG. 4. In other words, the data is extracted from the multi-tenant hosting system and placed in the internal file share component 121 so that it can be prepared for being downloaded to the customer's on-premise deployment. This is indicated by block 401 in FIG. 5.

The data in the internal file share component 121 is then submitted to scrubbing tool 310 where it is scrubbed so that it is in proper form to be downloaded and imported into the on-premise deployment. Scrubbing tool 310 will vary, depending on the particular application, and depending on the slight variances between the on-line version of the CRM application and the on-premise version of the CRM application. For instance, the data may be in a slightly different form when used in the on-line version, as opposed to when it is used in the on-premise version. Scrubbing tool 310 thus makes whatever deletions, additions, or transformations are required to place the data in proper form for the on-premise deployment. Again, it will be noted that since the code base of the two versions of the CRM application (the on-line version and the on-premise version) are substantially the same, scrubbing tool 310 will likely be making only relatively minor changes to the data.

Some such changes will include, by way of example, preserving data that was generated using on-line search features, but removing the on-line search features, themselves, so that they cannot be used in the on-premise version of the CRM application. In this way, all of the underlying data for the customer is preserved, but some of the features may be removed or added, or modified, given the differences between the on-line version of the CRM application and the on-premise version. Scrubbing the data is indicated by block 403 in FIG. 5.

Once the data has been scrubbed, it is placed in a solution packet in the secure file server data store 314 on secure file server 312. The solution packet can also optionally include additional files which may be needed by the customer in order to download and import the data into the on-premise version of the CRM application. Placing the scrubbed customer data and other needed files in the solution packet on the secure file server is indicated by block 405 in FIG. 5.

The host then notifies the customer that the solution packet is available, and provides the location of the solution packet and instructions needed to download the data onto the CRM client computer 102, for deployment in the on-premise version. This is indicated by block 407 in FIG. 5.

Next, the host determines whether the on-premise migration requested by the customer is complete. This is indicated at block 409. The on-premise migration may not be complete for a variety of reasons. For instance, in one illustrative embodiment, the customer may desire to perform a number of test migrations prior to migrating the final version of its CRM data to the CRM client computer 102. In that case, the host may allow the customer to request its data a plurality, but limited, number of times. In one exemplary embodiment, the host may allow the customer to request a data migration three times, for instance. Then, when the customer requests data from the host, the hosting agent notes the number of requests that have been made. If the number of requests is less than three, then the hosting agent, indicates that the customer can request its data an additional number of times in the future, when the hosting agent confirms to the customer that the request has been made. For instance, if this is the first request for data migration from the customer, then when the hosting agent confirms the request, the hosting agent also indicates that the customer can request its data two more times. Thus, at block 409, the hosting agent determines that the migration is not complete, but that this is only a test data migration.

This is also illustrated in FIG. 4. For instance, FIG. 4 shows that the scrubbed data in data store 314 may include a number of test copies illustrated by copies 410A, 410B and 410N in FIG. 4. After the maximum number of test copies have been scrubbed and placed in the secure file server 312, then when the customer requests data migration a final time, the final copy of the data 412 is retrieved, scrubbed and placed in the secure file server 312. Once the final copy of the data has been placed in the secure file server 312 and downloaded by the customer to CRM client computer 102, then the hosting agent determines, at block 409, that the on-premise migration is complete. The hosting agent then deletes the customer subscription to the hosted application, as requested by the customer. This is indicated by block 411 in FIG. 5. If, on the other hand, the on-premise migration is not complete as determined at block 409, then processing reverts to block 385, where the customer can again request its data for data back up or migration.

It should also be noted that a customer can use a hybrid system in which some of its users are using the on-line version of the CRM application and some are using the on-premise version. In that case, only certain user subscriptions are deleted at block 411 from the on-line version. Some user subscriptions to the on-line version will be maintained. Then, the user is responsible for maintaining synchronicity between the data in the unshared multi-tenant hosting environment at CRM hosting site 102 and the data in the on-premise environment on CRM client computer 102. It may be desirable to maintain a hybrid system so that some users can maintain the features associated with the on-line version of the CRM application, yet not all users maintain those features. Therefore, the client need not pay the subscription price for all of its users. This, of course, is optional and the customer need not maintain any subscriptions to the on-line version of the CRM application.

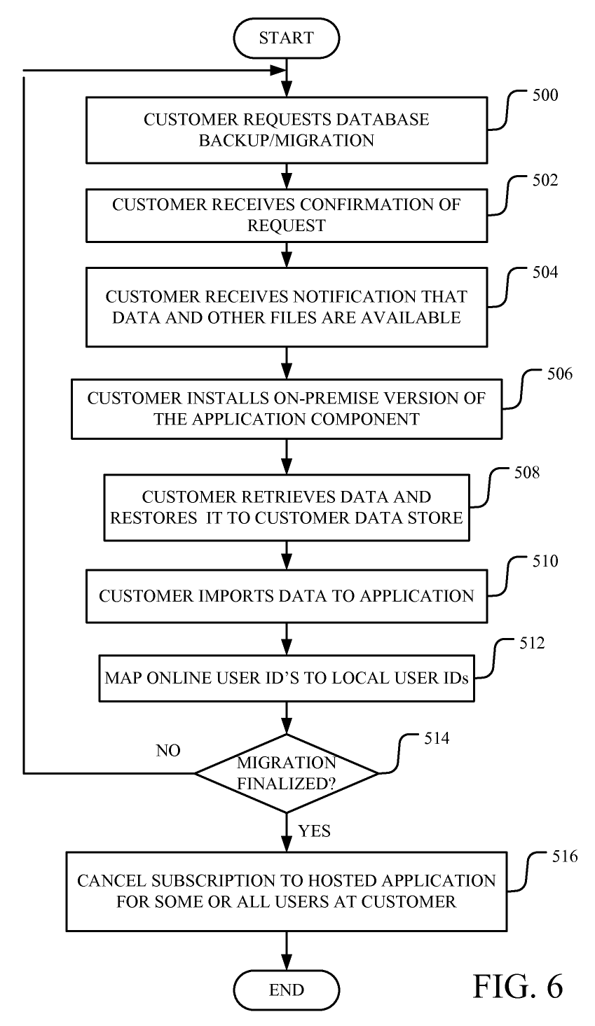

FIG. 6 is a flow diagram illustrating processing that occurs on CRM client computer 102 during the data migration. First, the customer requests data backup or migration from the on-line version to the on-premise version of the CRM application. This is indicated by block 500 in FIG. 6. As indicated above with respect to FIG. 5, the customer may do this by placing a telephone call to a hosting agent, or by placing the request through electronic communication to a human or automated hosting agent. In any case, the customer provides authentication information so that the hosting agent can authenticate the identity of the customer making the request. Once the request has been made and authenticated, the customer receives notification that the request has been confirmed by the hosting agent. This is indicated by block 502 in FIG. 6.

After the data has been retrieved and scrubbed at the hosting site, and placed in the secure file server, the customer receives notification that the data and other necessary files are available, along with the location of the data and files and instructions for downloading the data and files. This is indicated by block 504 in FIG. 6. Again, this notification can be sent manually, by a telephone call, or it can be sent electronically, through electronic mail or other type of electronic messaging or communications. If the customer has not already done so, the customer then installs the on-premise version of the CRM application, on computer 104 along with all the components required to run that application. This is indicated by block 506 in FIG. 5.

The customer then retrieves the scrubbed data and files stored in data store 314 at the CRM hosting site 102. The customer can do this by using a conventional download component 330 that downloads the CRM data, through database server 318, into data store 316. The customer downloads other application components or files into the on-premise CRM application 334 on the application server 320. For instance, there may be bug fixes or other updates to the on-premise CRM application that the hosting agent places in the secure file server 312 for download by the customer. In that case, download component 330 downloads those files to the CRM application on the application server 320. Retrieving and saving the data and files to the customer data store 316 and application server 320 is indicated by block 508 in FIG. 6.

The customer then uses import tool 332 to import the downloaded data into the CRM application, thus populating data structures for use by the CRM application. In one embodiment, the import tool 332 may be part of the CRM application 334 or separate from it. In either case, the import tool 332 may illustratively provide a number of dialog boxes which allow the customer to import the data into the application. This is indicated by block 510 in FIG. 6.

The customer then maps the users of the on-line version of the CRM application to users of the on-premise version of the CRM application. In one illustrative embodiment, this is also enabled by the import tool 332, which displays a number of dialog boxes that allow the customer to map the users, as desired. For instance, in the on-line version of the CRM application, users may need to be identified by a multi-jurisdictional passport type of identification. One such form of identification is referred to as a Windows Live ID which uniquely identifies a user among multiple jurisdictions or environments on-line. In migrating to an on-premise application, the customer may desire to map the users to local user identifications instead of the multi-jurisdictional identifiers. One example of a local identifier is an Active Directory identification. Mapping the on-line user IDs to local user IDs is indicated by block 512 in FIG. 6.

The customer then determines whether the migration has been finalized. For instance, if the data migration has been a migration of one of the test copies of data, then the migration is not yet complete, and processing reverts to block 500, where the user can again request its data for migration to the on-premise deployment. Alternatively, however, if this was the final data migration, and the migration to the on-premise deployment has been completed, then the customer can cancel user subscriptions to the hosted, on-line application for some or all users at the customer site. As discussed above, the user may wish to have an entirely on-premise system, in which case all user subscriptions to the on-line version of the application will be canceled. However, the user may wish to maintain either a dual system, or a hybrid system, in which some or all of its users maintain their subscriptions to the on-line version of the application, but some or all of whom also have local access to the on-premise version of the application. Determining whether the migration is finalized is indicated by block 514, and canceling subscriptions for some or all of the users of the on-line version of the application is indicated by block 516 in FIG. 6.

This type of data migration allows a customer of an on-line CRM deployment to switch to an on-premise deployment very quickly and easily, with no loss of data and substantially no interruption in service. It also allows the customer to schedule both test and final data migrations. The customer also controls mapping of on-line users to the local system.

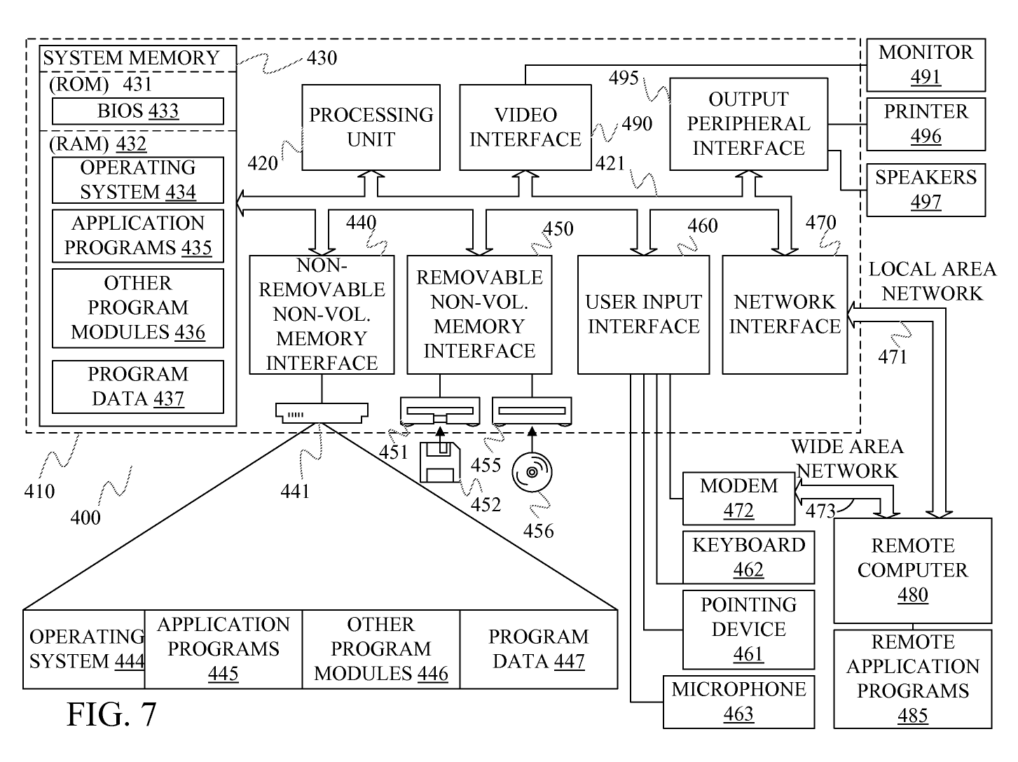

FIG. 7 illustrates an example of a suitable computing system environment 700 on which the invention may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment 700.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 7, an exemplary system for implementing the invention includes a general purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 4 illustrates operating system 734, application programs 735, other program modules 736, and program data 737.

The computer 710 may also include other removable/non-removable volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 455 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7, provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 445, other program modules 746, and program data 747 are given different numbers here to illustrate that, at a minimum, they are different copies. The components in system 100 and 104 can be in modules 746, programs 745, any of the servers, or elsewhere, including remotely.

A user may enter commands and information into the computer 710 through input devices such as a keyboard 762, a microphone 763, and a pointing device 761, such as a mouse, trackball or touch pad. Other input devices (not shown) may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer 710 may operate in a networked environment using logical connections to one or more remote computers, such as a remote computer 780. The remote computer 780 may be a personal computer, a hand-held device, a server, a router, a network PC, a peer device or other common network node, and typically includes many or all of the elements described above relative to the computer 710. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 410 typically includes a modem 472 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 485 as residing on remote computer 780. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of migrating data from a first deployment to a second deployment, comprising:
maintaining, with a computer processor, client data in the first deployment, the first deployment running a hosted version of a business application at a multi-tenant host that hosts the business application for a plurality of different tenants that access the business application over a wide area network, each tenant having its client data stored in a designated database, having a data store and a server, and the business application having a separate application server hosting the business application separately for each tenant;
receiving a tenant request, from a requesting tenant, to migrate client data for the requesting tenant from the first deployment to the second deployment, the second deployment running a non-hosted version of the business application for a single client having the client data stored in a local data store, local to the single client;
preparing a solution packet for the requesting tenant by extracting the tenant data for the requesting tenant in the first deployment, modifying the extracted tenant data with the computer processor, to ensure the tenant data is converted to a form that is compatible with the second deployment, and including in the solution packet instructions for migrating the tenant data;
storing the solution packet in a secure data store, accessible by the requesting tenant over the wide area network;
notifying the requesting tenant that the solution packet is available and providing a location of the solution packet; and
receiving a notification from the requesting tenant that the solution packet has been successfully downloaded to the second deployment from the secure data store over the wide area network.

2. The method of claim 1 wherein preparing a solution packet comprises:
preparing a plurality of solution packets including at least one test solution packet and a final solution packet.

3. The method of claim 2 and further comprising:
determining whether the solution packet downloaded by the second deployment is one of the at least one test solution packets or the final solution packet.

4. The method of claim 3 wherein users at the tenants subscribe to the first deployment, and further comprising:
if the solution packet downloaded to the second deployment is the final solution packet, then canceling subscriptions for at least some of the users at the requesting tenant.

5. The method of claim 4 wherein canceling subscriptions comprises:
receiving a request from the requesting tenant for a hybrid deployment, and in response to the request, canceling subscriptions for some, but not all, users at the requesting client.

6. The method of claim 1 wherein preparing a solution packet comprises:
including in the solution packet modifications to the non-hosted version of the business application.

7. The method of claim 1 and further comprising:
prior to preparing the solution packet, accessing a migration schedule to identify a time when fewer than a threshold number of solution packets are scheduled to be prepared; and
scheduling preparation of the solution packet for the identified time and notifying the requesting tenant of the time when preparation of the solution packet for the requesting tenant is scheduled.

8. The method of claim 1 and further comprising:
prior to preparing the solution packet, authenticating that an entity at the requesting tenant making the request has authority to make the request.

9. A method of switching from using a hosted version of a business application hosted over a wide area network by a host, remote from a client, to an on-premise version of the business application local to the client, comprising:
requesting client data generated and maintained using the hosted version of the business application and stored at the host;
receiving a notification indicating that a scrubbed version of the client data is available to the client, over the wide area network, at a secure server at the host, the scrubbed version of the client data being modified from a form used by the hosted version of the business application to a form used by the on-premise version of the business application;
downloading the scrubbed version of the client data over the wide area network, using a computer processor, to a database local to the client;
importing the scrubbed version of the client data to the on-premise version of the business application using an import tool implemented by the computer processor;
mapping users of the hosted version of the business application to the on-premise version of the business application using the import tool; and
using the on-premise version of the business application.

10. The method of claim 9 wherein mapping users comprises:
assigning the users of the hosted version of the business application, identified by the hosted version of the business application by multi-jurisdictional identifiers, to the on-premise version of the business application using local identifiers that identify the users to the on-premise version of the business application.

11. The method of claim 9 wherein requesting client data comprises:
prior to using the on-premise version of the business application, requesting a test version of the client data and performing the steps of downloading and importing the test version of the client data.

12. The method of claim 11 wherein requesting client data comprises:
prior to using the on-premise version of the business application, requesting a final version of the client data and performing the steps of downloading and importing the final version of the client data.

13. The method of claim 12 and further comprising:
notifying the host that the final version of the client data has been downloaded and imported to the on-premise version of the business application.

14. The method of claim 12 and further comprising:
installing the on-premise version of the business application on the client; and
verifying to the host that a licensed copy of the on-premise version of the business application has been installed on the client.

15. The method of claim 9 wherein users of the hosted version of the business application have subscriptions to use the hosted version of the business application, and further comprising:
requesting the host to cancel subscriptions for at least some users at the client.

16. The method of claim 15 wherein requesting the host to cancel subscriptions comprises:
requesting the host to cancel some, but not all subscriptions of users at the client.

17. A system for hosting a hosted version of a business application for use by tenants over a wide area network, comprising:
a multi-tenant data hosting component hosting client data for a plurality of different tenants, each tenant having an assigned database server;
an application server hosting the hosted version of the business application for each of the plurality of different tenants;
a scrubbing component receiving client data for a requesting tenant that has requested migration of its client data from the multi-tenant data hosting component to a local database, local to the requesting tenant, the scrubbing component modifying the client data from a form used by the hosted version of the business application to scrubbed data in a form used by a local version of the business application used by the requesting tenant;
a secure file server accessible by the requesting tenant; and
a computer processor being a functional component of the system and activated by the scrubbing component to facilitate modifying of the client data and placing the scrubbed data in the secure file server.

18. The system of claim 17 wherein the scrubbing component removes on-line functional features from the client data but preserves the client data itself.

19. The system of claim 17 wherein the scrubbing component generates at least one test set of scrubbed client data and one final set of scrubbed client data for the requesting tenant.

20. The system of claim 17 wherein the multi-tenant hosting component discontinues hosting client data for the requesting tenant based on a subscription cancellation request received from the requesting tenant.
